(19) United States
(12) Patent Application Publication
(10) Pub. No.: US 2021/0214622 A1
(43) Pub. Date: Jul. 15, 2021

(54) PROCESS OF UPGRADING LIGHT HYDROCARBONS AND OXYGENATES PRODUCED DURING CATALYTIC PYROLYSIS OF BIOMASS

(71) Applicant: INAERIS TECHNOLOGIES, LLC, Pasadena, TX (US)

(72) Inventors: Richard A. ENGELMAN, Houston, TX (US); Vicente SANCHEZ, Houston, TX (US)

(21) Appl. No.: 16/073,758

(22) PCT Filed: Nov. 23, 2016
(86) PCT No.: PCT/US2016/063674

§ 371 Date: Jul. 27, 2018

Related U.S. Application Data
(60) Provisional application No. 62/258,909, filed on Nov. 23, 2015.
(60) Provisional application No. 62/264,294, filed on Dec. 7, 2015.

(51) Int. Cl. C10G 50/00; C10G 1/00; C10G 3/00; C10L 1/04

(52) U.S. Cl. CPC C10G 50/00; C10G 1/002; C10G 3/54; C10G 2300/1092; C10G 2300/4018; C10G 2300/1011; C10L 1/04

(57) ABSTRACT

The C₂-C₄ olefms and dienes and/or C₁-C₄ oxygenates in produced gas resulting from the catalytic pyrolysis of hiomass may he upgraded to C₅+ hydrocarbons and/or C₅+ oxygenates in the gaseous phase or in the liquid phase. In addition, the C₂-C₄ olefins and dienes and/or C₁ -C₄ oxygenates in produced water maybe upgraded to C₅+ hydrocarbons and/or C₅+ oxygenates in the gaseous phase.

### FIELD OF THE DISCLOSURE

The disclosure relates to a method of upgrading light hydrocarbons and light oxygenates produced during the catalytic pyrolysis of biomass.

### BACKGROUND OF THE DISCLOSURE

In light of its low cost and wide availability, biomass is often used as a feedstock to produce bio-oil. Bio-oil, in turn, is used to produce biofuel, a renewable energy source and a substitute for fossil fuel.

A well-known process for converting biomass to bio-oil is thermocatalytic pyrolysis. After the removal of solid materials, the pyrolysis effluent may be defined by a gas phase and a liquid phase. The liquid phase may be separated into an aqueous phase and a bio-oil containing organic phase which may be processed into transportation fuels as well as into hydrocarbon chemicals and/or specialty chemicals. The aqueous phase contains water present in the biomass prior to conversion as well as water produced during thermocatalytic pyrolysis. The aqueous phase, as well as the gas phase, contain low molecular weight olefins, diolefins and oxygenates.

While thermocatalytic pyrolysis produces high yields of bio-oil, a high percentage of the bio-oil is of low quality due to the presence of high levels of low molecular weight oxygenates having 4 or less carbon atoms (C₄₋ ) and low molecular weight (C₄₋) olefins (principally composed of propylene, butadiene, butene and propene). Exemplary C₄₋ oxygenates are alcohols, aldehydes, unsaturated aldehydes, ketones, unsaturated ketones, carboxylic acids, glycols, esters, furan and the like. The efficiency in upgrading of bio-oil to fuels is seriously hampered by the presence of such low molecular weight olefins and oxygenates.

In the past, oxygenates in the oil phase and liquid phase have been converted to hydrocarbons by hydrotreating where stream is contacted with hydrogen under pressure and at moderate temperatures, generally less than 850° F., over a fixed bed reactor. Transportations fuels predominately contain hydrocarbons having five or more carbon atoms (C₅+) (though small amounts of C₄ hydrocarbons are present in some gasolines during cold season). Thus, hydrocarbons derived by hydrotreating C₄− oxygenates, as well as C₄₋ olefins, are of little value in transportation fuels. Additionally, hydrotreating C₄− oxygenates consumes valuable hydrogen in the reactor.

Thus, the efficiency of secondary upgrading of bio-oil is compromised by the presence of the C₄− oxygenates as well as the C₄₋ olefins. Processes for upgrading C₄₋ olefins and C₄₋ oxygenates to C₅+ olefins and C₅+ oxygenates are therefore desired.

### SUMMARY OF THE DISCLOSURE

In an embodiment of the disclosure, a process of upgrading C₂-C₄ olefins, C₂-C₄ dienes and/or C₁-C₄ oxygenates in produced gas and in an aqueous phase product to C₅+ hydrocarbons and/or C₅+ oxygenates is provided. The produced gas and the aqueous phase being effluents from the catalytic pyrolysis of biomass.

In an embodiment, the C₂-C₄ olefins, C₂-C₄ dienes and C₁-C₄ oxygenates in the produced gas and the aqueous phase product may be upgraded to C₅+ hydrocarbons and C₅+ oxygenates in the gaseous phase.

In another embodiment, the C₂-C₄ olefins, C₂-C₄ dienes and C₁-C₄ oxygenates in the produced gas and the aqueous phase product may be upgraded to C₅+ hydrocarbons and C₅+ oxygenates from components of produced gas absorbed into the liquid phase.

In another embodiment, the C₂-C₄ olefins, C₂-C₄ dienes and C₁-C₄ oxygenates in the produced gas and the aqueous phase product may be upgraded to C₅+ hydrocarbons and C₅+ oxygenates from components in the aqueous phase vaporized into the gaseous phase.

In another embodiment, the C₂-C₄ olefins, C₂-C₄ dienes and C₁-C₄ oxygenates in the produced gas and the aqueous phase product may be upgraded to C₅+ hydrocarbons and C₅+ oxygenates from a combined gaseous stream containing C4− components from the produced gas and aqueous phase.

In another embodiment of the disclosure, a process of enhancing the yield of biofuel from biomass catalytically converted in a biomass conversion unit is provided. In this embodiment, a produced gas phase and an aqueous phase product, both containing C₂-C₄ olefins, C₂-C₄ dienes and C₁-C₄ oxygenates, are separated from effluent from the biomass conversion unit.

In an embodiment, the C₂-C₄ olefins, C₂-C₄ dienes and C₁-C₄ oxygenates in the produced gas phase and the aqueous phase product may be converted to C₅+ hydrocarbons and C₅+ oxygenates from components of produced gas in the gaseous phase.

In another embodiment, the C₂-C₄ olefins, C₂-C₄ dienes and C₁-C₄ oxygenates in the produced gas phase and the aqueous phase product may be converted to C₅+ hydrocarbons and C₅+ oxygenates from components of produced gas absorbed into the liquid phase.

In another embodiment, the C₂-C₄ olefins, C₂-C₄ dienes and C₁-C₄ oxygenates in the produced gas phase and the aqueous phase product may be converted to C₅+ hydrocarbons and C₅+ oxygenates from components in the aqueous phase vaporized into the gaseous phase.

In another embodiment, the C₂-C₄ olefins, C₂-C₄ dienes and C₁-C₄ oxygenates in the produced gas phase and the aqueous phase product may be converted to C₅+ hydrocarbons and C₅+ oxygenates from a combined gaseous stream containing C4− components from the produced gas and aqueous phase.

In an embodiment, the C₂-C₄ olefins, C₂-C₄ dienes and/or C₁-C₄ oxygenates in the produced gas are converted to C₅+ hydrocarbons and/or C₅+ oxygenates in a catalytic gas reactor. Soluble organic materials may be extracted from a liquid phase containing the C₅+ hydrocarbons and C₅+ oxygenates.

In another embodiment, the produced gas is subjected to absorption by means of a gas scrubber utilizing a liquid medium to remove some of the oxygenates, resulting in a liquid stream enriched in oxygenates and a scrubbed process gas stream depleted of the oxygenates and containing the C₂-C₄ olefins and dienes. The C₂-C₄ olefins and dienes may then be converted in the scrubbed process gas stream to C₅+ hydrocarbons in a gas phase catalytic reactor.

In another embodiment, the produced gas containing C₂-C₄ olefins and dienes and C₁-C₄ oxygenates may be subjected to a first gas phase catalytic reactor in the presence of a first catalyst to produce a gas enriched in C₅+ hydrocarbons and oxygenates products and a gas enriched in reacted C₂-C₄ olefins and dienes. The gas enriched in C₅+ hydrocarbons and oxygenates products may then be condensed. The gas enriched in C₂-C₄ olefins and dimes may then be fed to a second gas phase catalytic reactor in the presence of a second catalyst to render a gas enriched in C₅+ hydrocarbons products.

In another embodiment, produced gas from a biomass catalytic pyrolysis conversion unit may be scrubbed with a liquid medium to produce a liquid stream enriched in C₁-C₄ oxygenates and hydrocarbons. The C₁-C₄ oxygenates may then be converted to a C₅+ oxygenate and hydrocarbon containing stream in a liquid phase catalytic reactor.

In another embodiment, produced water may be subjected to a gaseous medium in a gas scrubber to render a process gas stream enriched in C₁-C₄ oxygenates. The C₁-C₄ oxygenates in the scrubbed gas stream may then be converted to C₅+ oxygenates and hydrocarbons in a gas phase catalytic reactor.

### BRIEF DESCRIPTION OF THE DRAWINGS

In order to more fully understand the drawings referred to in the detailed description of the present disclosure, a brief description of each drawing is presented, in which:

FIG. 1 illustrates a process of upgrading C₂-C₄ olefins, C₂-C₄ dienes and/or C₁-C₄ oxygenates in produced gas to C₅+ hydrocarbons and C₅+ oxygenates in the gaseous phase.

FIG. 1A illustrates a process of regenerating catalyst from a fluidized bed reactor during the upgrading of C₂-C₄ olefins, C₂-C₄ dienes and/or C₁-C₄ oxygenates to C₅+ hydrocarbons and C₅+ oxygenates.

FIG. 1B illustrates a process of regenerating catalyst from a fixed bed reactor during the upgrading of C₂-C₄ olefins, C₂-C₄ dienes and/or C₁-C₄ oxygenates to C₅+ hydrocarbons and C₅+ oxygenates.

FIG. 2 illustrates a process of upgrading C₁-C₄ oxygenates in a produced gas effluent (from the catalytic pyrolysis of biomass) to C₅+ hydrocarbons and C₅+ oxygenates in the gaseous phase.

FIG. 3 illustrates a process of upgrading C₂-C₄ olefins and/or the C₁-C₄ oxygenates in a produced gas effluent and an aqueous phase (effluents from the catalytic pyrolysis of biomass) from the catalytic pyrolysis of biomass to C₅+ olefins and C₅+ oxygenates in the gaseous phase using gas/liquid and liquid/gas extraction.

FIG. 4 illustrates a process of upgrading C₂-C₄ olefins, C₂-C₄ dienes and C₁-C₄ oxygenates in a produced gas effluent from the catalytic pyrolysis of biomass to C₅+ hydrocarbons and C₅+ oxygenates using multiple catalytic reactors.

FIG. 5 illustrates a process of removing C₁-C₄ oxygenates using gas/liquid extraction from a produced gas effluent from the catalytic pyrolysis of biomass and then upgrading the C₂-C₄ olefin and diene enriched gas stream to C₅+ hydrocarbons in the gas phase.

FIG. 6 illustrates a process of upgrading C₁-C₄ oxygenates in an aqueous stream water effluent from the catalytic pyrolysis of biomass to C₅+ hydrocarbons and C₅+ oxygenates in the gaseous phase.

FIG. 7 illustrates a process of upgrading C₁-C₄ oxygenates in produced gas to C₅+ oxygenates in the liquid phase.

FIG. 8 illustrates the tubular fixed bed reactor used in Examples 1and 2.

FIG. 9 is a Gas Chromatography-Mass Spectrometry (GC-MS) chromatogram for the oil produced in Example 1 simulating the upgrading of C₁-C₄ olefins and/or the C₁-C₄ oxygenates in a produced gas to C₅+ olefins and/or C₅+ oxygenates in the gaseous phase

FIG. 10 is a GC-MS chromatogram for the oil produced in Example 2 simulating the upgrading of C₂-C₄ olefins and/or the C₁-C₄ oxygenates in a produced gas to C₅+ olefins and/or C₅+ oxygenates in the gaseous phase.

FIG, 11 is a GC-MS chromatogram for the aqueous phase produced in Example 2.

FIG. 12 is a GC-MS chromatogram for an oil-dispersed phase of oxygenates upgraded by the process disclosed herein.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended figures, being of example embodiments, are not intended to limit the claims of this patent or any patent or patent application claiming priority hereto. On the contrary, the intention is to cover all modifications, equivalents and alternatives falling within the spirit and scope of the claims. Many changes (nay be made to the particular embodiments and details disclosed herein without departing from such spirit and scope.

Certain terms are used herein and in the appended claims to refer to particular components. As one skilled in the art will appreciate, different persons may refer to a component by different names. This document does not intend to distinguish between components that differ in name but not function.

Also, the terms “including” and “comprising” are used herein and in the appended claims in an open-ended fashion, and thus should be interpreted to mean “including, but not limited to . . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

The description and examples are presented solely for the purpose of illustrating the preferred embodiments of the disclosure and should not be construed as a limitation to the scope and applicability of the disclosure.

Each numerical value set forth herein should be read once as modified by the term “about” (unless already expressly so modified), and then read again as not so modified unless otherwise indicated in context. Also, it should be understood that a concentration range listed or described as being useful, suitable, or the like, is intended that any and every concentration within the range, including die end points, is to be considered as having been stated. For example, “a range of from 1 to 10” is to be read as indicating each and every possible number along the continuum between about 1 and about 10.

The disclosure relates to a process of upgrading light olefins and dienes and light oxygenates which are produced during the catalytic pyrolysis of biomass. Normally, such materials are considered a waste product since they cannot be converted into C₅+ fuel. As such, they are presently used only as a heat source.

Typically, from about 10% to about 15% of elemental carbon in the biomass fed to the biomass conversion unit leave that unit in the form of light olefins, dienes and oxygenates. The process of the disclosure enables such light olefins, dienes and oxygenates to be upgraded to heavier materials. The process of the disclosure thus provides a means to recover such light materials and use such materials as fuel.

Light olefins as referenced herein include unsaturated hydrocarbons having less than five carbon atoms (C₄₋ olefins) and include ethylene, propylene, butenes, iso-butenes and allenes and mixtures thereof. Light dienes include propadiene and butadiene and mixtures thereof. Light oxygenates are those containing less than five carbon atoms (C₄₋ oxygenates) and include formaldehyde, methanol, acetaldehyde, butyraldehyde, ethanol, furan, acrolein, acetone, propanal, propanol, methyl vinyl ketone, methacrolein, butanal, acetic acid, propionic acid and mixtures thereof; and the C₂-C₄ olefins and dienes are selected from the group consisting of ethylene, propylene, isobutene, butenes, propadiene, butadiene, and mixtures thereof.

The produced gas and the aqueous phase referenced herein are effluent streams from the catalytic pyrolysis of biomass. Typically, the conversion effluent from the biomass conversion unit includes solids and fluid (e.g. gas and vapors). The solids are normally separated from the fluid in a solids separator. The solids may include char, coke and spent and/or used biomass conversion catalyst (BCC). The fluid stream exiting the solids separator is substantially solids-free and is separated into non-condensable gas (NCG), process water and an organic-enriched phase.

Typically, about 20 to 30 percent of C₄− olefins, butadiene and C₄− oxygenates are in the aqueous phase of the pyrolytic effluent while 60 to 70 percent are in the gas phase; the remaining being in the oil phase.

In an embodiment, the biomass particles can be fibrous biomass materials having components selected from lignin, cellulose, hemicelluloses as well as mixtures thereof. Examples of suitable cellulose-containing materials include algae, paper waste, and/or cotton linters. in one embodiment, the biomass particles can comprise a lignocellulosic material. Examples of suitable lignocellulosic materials include forestry waste such as wood chips, saw dust, pulping waste, and tree branches; agricultural waste such as corn stover, wheat straw, and bagasse; and/or energy crops such as eucalyptus, switch grass, miscanthus, coppice and fast-growing woods, such as willow and poplar.

The C₄₋ olefins, butadienes and the C₄₋ oxygenates in the gaseous phase and the aqueous phase may be upgraded to C₅+ hydrocarbons and C₅+ oxygenates by the processes disclosed herein. For instance, the C₂-C₄ olefins and dienes and the C₁-C₄ oxygenates in the produced gas and the aqueous phase may he upgraded to C₅+ hydrocarbons and/or C₅+ oxygenates while in a gaseous phase. In another embodiment, the C₂-C₄ olefins and dienes and the C₁-C₄ oxygenates in the produced gas and the aqueous phase may be upgraded to C₅+ hydrocarbons and/or C₅+ oxygenates from components of produced gas absorbed into the liquid phase. Further, the C₂-C₄ olefins and dienes and. C₁-C₄ oxygenates in the produced water and aqueous stream may he upgraded to C₅+ hydrocarbons and C₅+ oxygenates from components in the aqueous phase vaporized into the gaseous phase. in another embodiment, the C₂-C₄ olefins and dienes and the C₁-C₄ oxygenates in produced gas and the aqueous stream may be upgraded to C₅+ hydrocarbons and/or C₅+ oxygenates from a combined gaseous stream containing C4− components from the produced gas and aqueous phase.

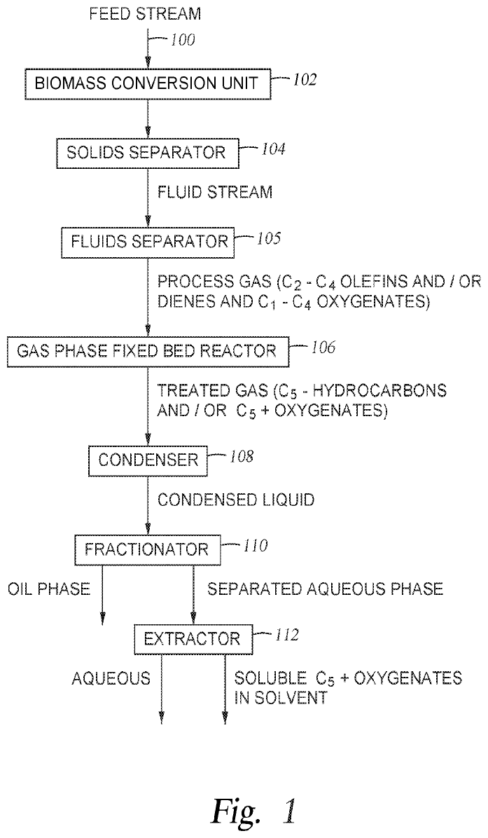

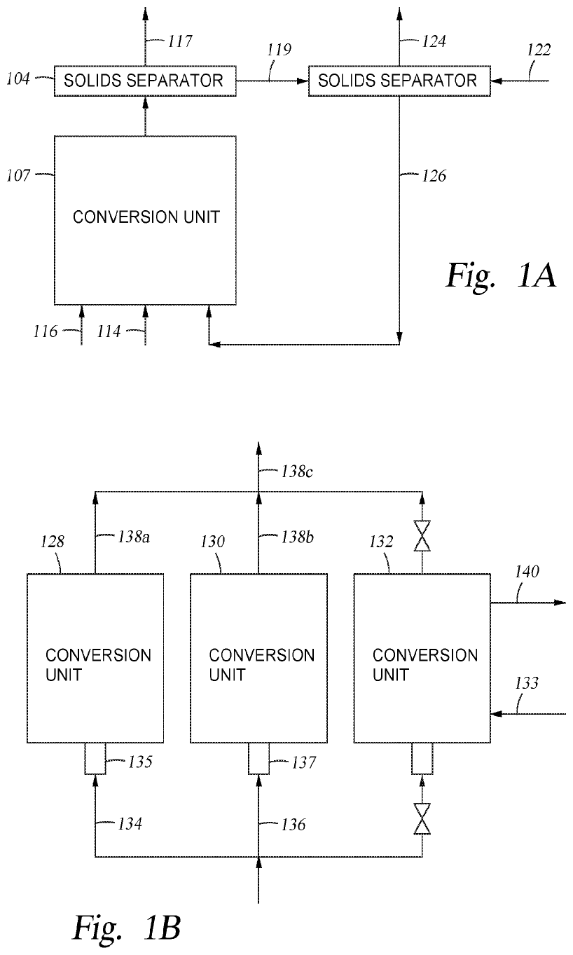

FIG. 1 is an exemplary process of upgrading the C₂-C₄ olefins and dienes and C₁-C₄ oxygenates in a produced gas stream to C₅+ hydrocarbons and/or C₅+ oxygenates. The upgrading of the C₂-C₄ olefins and/or the C₁-C₄ oxygenates occurs in the gas phase.

As illustrated, biomass stream 100 is first subjected to catalytic pyrolysis in biomass conversion unit 102 which may be a fluidized bed reactor. fixed bed reactor, cyclone reactor, ablative reactor, auger reactor, riser reactor, trickle bed configuration, another bed regimen or a combination thereof. Typically, biomass conversion unit 102 is a fixed bed reactor or a fluidized bed reactor.

When the reactor is a fluidized bed, the components of the catalyst should have a shape and size to be readily fluidized. Preferred are components in the form of microspheres having a particle size in the range of 20 μm to 3000 μm.

In the reactor, solid biomass particles may be agitated, for example, to reduce the size of particles. Agitation may be facilitated by a gas including one or more of steam, flue gas, carbon dioxide, carbon monoxide, hydrogen, and hydrocarbons such as methane. The agitator further be a mill (e.g., ball or hammer mill) or kneader or mixer.

Any suitable biomass conversion catalyst (BCC) may be used in the biomass conversion unit 102. For example, the BCC may be (i) a solid acid, such as a zeolite, super acid, clay, etc., (ii) a solid base, such as metal oxides, metal hydroxides, metal carbonates, basic clays, etc., (iii) a metal or a compound containing a metal functionality, such as Fe, Cu, Ni, and may include transition metal sulfides, transition metal carbides, etc., or (iv) an amphoteric oxide, such as alumina, silica, titania, etc. The residence time of the biomass in the. biomass conversion unit, for example, may be under 20 seconds at temperatures between from about 250 to about 1,000° C.

Solid materials from the conversion effluent are separated in solids separator 104 and the fluid stream is introduced into fluids separator 105 where non-condensible process gas, the aqueous stream and an organic-enriched phase are separated. Process gas containing C₂-C₄ olefins and dienes and C₁-C₄ oxygenates are fed into gas phase fixed bed reactor 106 and upgraded to C₅+hydrocarbons and C₅+ oxygenates.

The temperature in the fixed bed reactor is typically between from about 100° C. to about 700° C., preferably between from about 200° C. to about 400° C. Further, the space velocity in the fixed bed reactor is between from about 500 to about 10,000. Higher rates of conversion of C₂-C₄ olefins and/or the C₁-C₄ oxygenates into C₅+ olefins and/or C₅+ oxygenates occur at lower space velocities.

The catalyst in the fixed bed reactor may be (i) an acidic catalyst such as a zeolite including ZSM-5 and zeolite USY or a mixture thereof; (ii) a basic catalyst such as an alkaline-exchanged zeolite, alkaline earth-exchanged zeolite, basic zeolite, alkaline earth metal oxide, cerium oxide, zirconium oxide, titanium dioxide, mixed oxides of alkaline earth metal oxides and combinations thereof and mixed oxides selected from the group of magnesia-alumina, magnesia-silica, titania-alumina, titania-silica, cerin-alumina, ceria-silica, zirconia-alumina, zirconia-silica and mixtures thereof and wherein the exchanged zeolite has from about 40 to about 75% of exchanged cationic sites; (iii) a catalyst containing Cu, Ni, Cr, W, Mo, a metal carbide, a metal nitride, a metal sulfide or a mixture thereof; or (iv) a metallic hydroxide. The latter includes layered double hydroxides.

Further, a catalyst can be selected for use in the fixed bed reactor having specificity for the production of oxygenates or olefins. For instance, alkaline earth basic catalysts, such as hydrotalcite [like a layered double hydroxide of general formula Mg₆Al₂CO₃(OH)₁₆ 4(H₂O)] as well as hydrotalcites containing calcium selectively produces C₅₊ hydrocarbons and C₅₊ oxygenates in the fixed bed reactor.

During upgrading of light oxygenates, olefins and dienes in reactor 106, deposition of carbonaceous material on the surface or in the pores of the catalyst may deactivate the catalyst. When this occurs, it is economically advantageous to regenerate the spent catalyst by controlled combustion of the carbonaceous material.

FIG. 1A exemplifies regeneration of spent catalyst where conversion unit 107, an upgrading reactor, is a moving bed, such as a fluidized bed. As depicted, gas phase stream 114 containing light oxygenates and/or light hydrocarbons is fed into the reactor, optionally along with heated catalyst 116. Spent catalyst 119 (deactivated with carbonaceous deposits) and vapors 117 are separated in solids separator 104. Solids separator 104 may be a cyclone or hot gas filter. Stream 119 containing spent catalyst is then fed into regeneration unit 120. In regeneration unit 120, the heated catalyst is mixed with oxygen or oxygen containing gas (such as air) 122 and the carbonaceous deposits are combusted to form a flue gas 124 which includes carbon dioxide and water. Regenerated catalyst 126, having restored activity is separated from the flue gas (such as by an internal cyclone) and is returned to reactor 107.

Regeneration of spent catalyst can further be accomplished while the catalyst is loaded in the reactor using a redundant or dual catalytic system. FIG. 1B exemplifies regeneration of a spent catalyst where biomass conversion units 128, 130 and 132 are fixed bed reactors. The three biomass conversion units are illustrated as being in parallel. Each biomass conversion unit may, in turn, contain multiple reactor vessels, either in series or in parallel.

In FIG. 1B, conversion units 128 and 130 are on-line and feedstreams containing light hydrocarbons and/or oxygenates 134 and 136, respectively, are fed into the conversion units through inlet ports 135 and 137. The gas phase streams may be fed into the reactor system as two separate streams or a common stream (as depicted) and divided into two streams for entry into inlet ports 135 and 137. Reactor effluent 138a and 138b is fed into a solids separator. Reactor effluent 138a and 138b may be fed as separate streams into the solids separator or as a combined stream 138c (shown in PIG-. 1B). Conversion unit 132 is off-line for catalyst regeneration. Inlet port 139 for conversion unit 132 is closed and oxygen or an oxygen containing gas 133 is introduced into conversion unit 132. Carbonaceous material combusts to form carbon dioxide and water inside conversion unit 132 which exits as flue gas 140. Once regeneration of catalyst in conversion unit 132 is completed, it can be placed on-line and either conversion unit 128 or 130 can be brought off-line for regeneration of the catalyst.

A stream enriched in C₅+ hydrocarbons and/or C₅+ oxygenates may then be fed into condenser 108 and the resulting liquid containing C₅+ hydrocarbons and/or C₅+ oxygenates may then be separated in fractionator 110 into an oil phase and an aqueous phase. Soluble oxygenates in the separated aqueous phase, including C₅+ oxygenates, may be extracted in extractor 112 Oxygenates dissolved in the aqueous phase can be extracted. Suitable solvents for extracting soluble organic materials from the liquid phase include methyl isobutyl ketone and ethyl acetate.

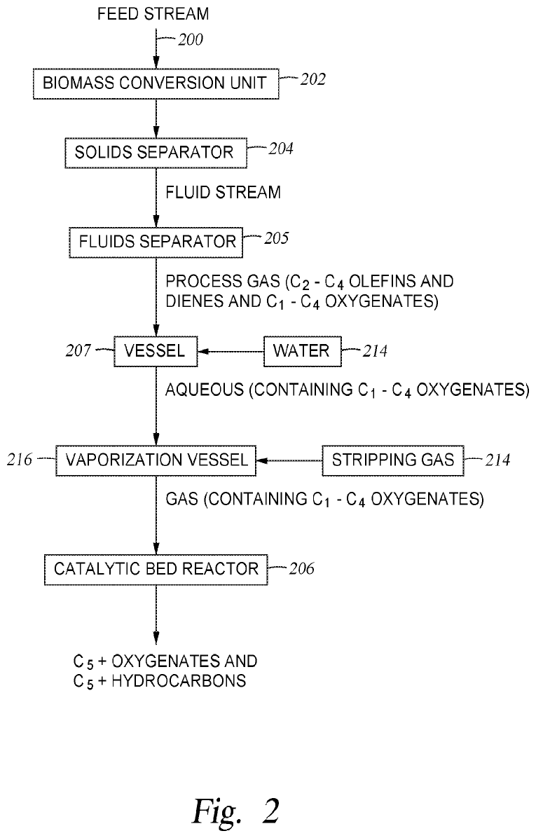

FIG. 2 illustrates a process of upgrading C₁-C₄ oxygenates in produced gas using gas/liquid extraction wherein biomass stream 200 is subjected to catalytic pyrolysis in biomass conversion unit 202. The conditions in biomass conversion unit 202 may the same as those set forth above in biomass conversion unit 102.

Solid materials from the conversion effluent are separated in solids separator 204 and the fluid stream introduced into fluids separator 205 where non-condensible process gas is separated from the aqueous phase and the organic-enriched phase. The C₁-C₄ oxygenates are absorbed from the process gas containing C₂-C₄ olefins, or both C₂-C₄ olefins and C₁-C₄ oxygenates using water 214 as an absorption medium in vessel 207. in vessel 207, the process gas may be scrubbed under conditions favoring the absorption of C₁-C₄ oxygenates. The pressure in the scrubbing vessel is between from about 1 and 10 bar and more typically is atmospheric.

The aqueous stream from vessel 207 enriched in C₁-C₄ oxygenates may then be fed into vaporization vessel 216 such as a gas stripper and the C₁-C₄ oxygenates may then be transported into a gas containing the C₁-C₄ oxygenates. Suitable stripping gas 215 includes nitrogen and steam. The gas enriched in C₁-C₄ oxygenates is then fed into fixed bed catalytic bed reactor 206. Conditions in reactor 206 are similar to those set forth for reactor 106. The stream exiting reactor 206 is enriched in C₅+ oxygenates and C₅+ hydrocarbons and may be processed into a transportation fuel. The C₅+ oxygenates and hydrocarbons produced in the catalytic gas phase reactor may be condensed and the oil containing the C₅+ oxygenates and hydrocarbons separated.

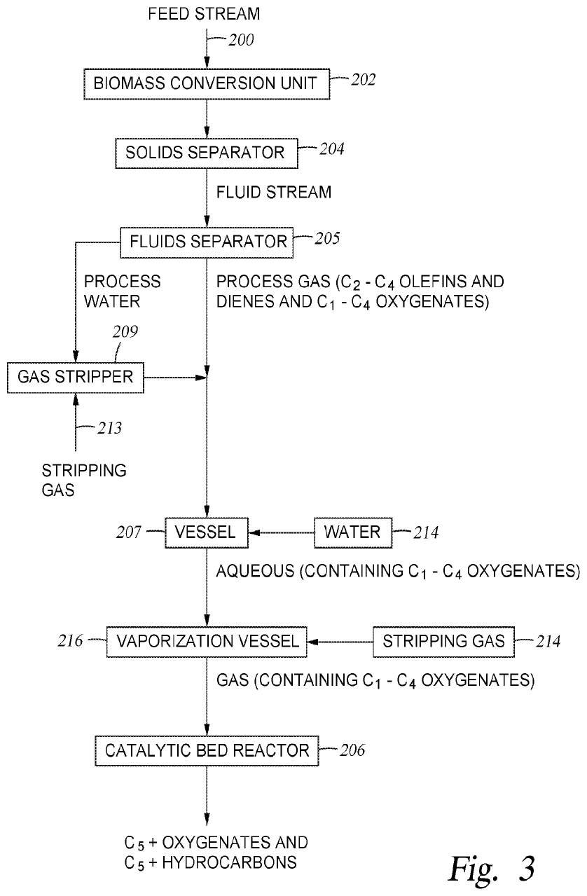

Another embodiment of the disclosure is set forth in FIG. 3. FIG. 3 illustrates a similar to the process set forth in FIG. 2. However, process water separated in fluids separator 205 is fed into gas stripper 209 and is treated with stripping gas 213, typically nitrogen or steam, Gas 217 enriched in light oxygenates is then combined with the process gas from fluids separator 205. The combined stream is then passed to vessel 216. The gas stream from 216 is then fed to fixed bed catalytic (gas) bed 206. The product stream is enriched in C₅+ oxygenates as well as C₅+ hydrocarbons.

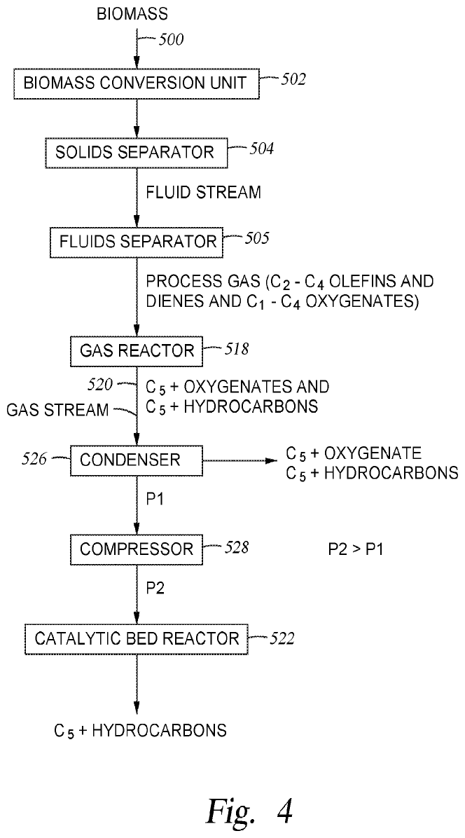

FIG. 4 illustrates an embodiment of the disclosure wherein C₂-C₄ olefins and/or the C₁-C₄ oxygenates are upgraded in different fixed bed (gaseous) reactors. Referring to FIG. 4, biomass 500 is subjected to catalytic pyrolysis in biomass conversion unit 502 in the manner discussed above. The biomass conversion catalyst (BCC) may be any of the referenced BCCs. Solid materials from the conversion effluent are separated in solids separator 504 and the fluid stream is introduced into fluids separator 505 where non-condensible process gas, process water and an organic-enriched phase are separated. Process gas containing C₂-C₄ olefins and dienes and C₁-C₄ oxygenates or both C₂-C₄ olefins and C₁-C₄ oxygenates is fed into first fixed bed (gas) reactor 518 at low pressures (typically between from about 1 and 10 bar and more typically at atmospheric) and the C₁-C₄ oxygenates are converted to C₅+ hydrocarbons and C₅+ oxygenates in gas stream 520. The stream is then condensed in condenser 526 and the liquid stream enriched in C₅+ hydrocarbons and C₅+ oxygenates is then processed into transportation fuels.

The remaining gas stream is then compressed to a higher pressure, P2, (typically between from about 40 to about 60 bar) in compressor 528 and is then passed to a second catalytic treatment in second fixed bed (gas) reactor 522 where C₂-C₄ olefins are oligomerized. into C₅+ olefins. Conditions in second fixed bed (gas) reactor 522 favor the upgrading of C₂-C₄ olefins into C₅+ olefins. The catalyst used in first fixed bed reactor 518 is different from the catalyst used in second fixed bed reactor 518. The removal of CI-C4 oxygenates from the gas stream prior to compression is desirable since the C₁-C₄ oxygenates cause fouling of the fixed bed during compression. Typically, the catalyst used in the oligomerization of olefins are acid catalysts such as those set forth above.

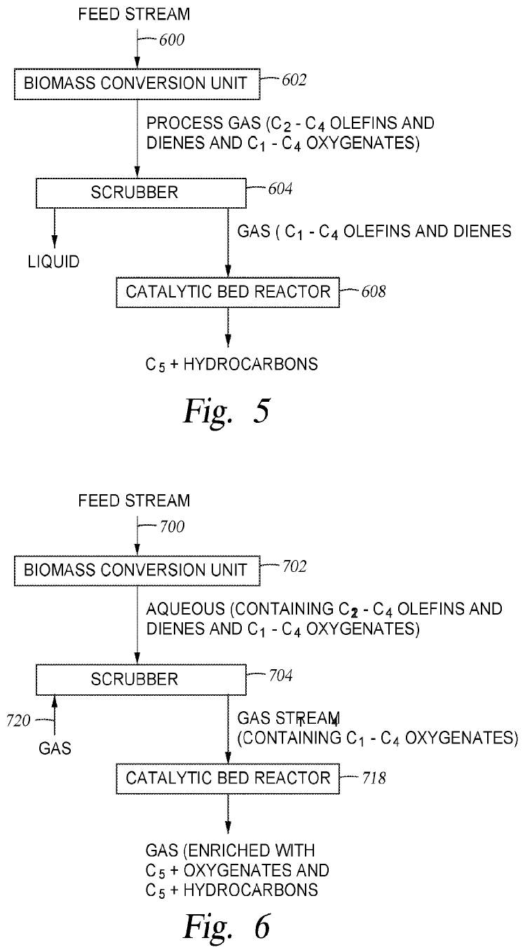

FIG. 5 illustrates another embodiment of the disclosure wherein biomass 600 is catalytically pyrolyzed in biomass conversion unit 602 to render produced gas containing C₂-C₄ olefins and dienes and C₁-C₄ oxygenates. The produced gas may then be introduced into scrubber 604 and C₁-C₄ oxygenates are absorbed into a liquid medium 606 introduced into the scrubber. The liquid medium is water or an aqueous solution. The resulting liquid stream is enriched in oxygenates and the scrubbed gas stream is depleted of oxygenates. The scrubbed gas stream contains enriched C₁-C₄ olefins and dienes. The enriched C₁-C₄ olefins and dienes in the scrubbed process gas stream may then be converted to C₅+ hydrocarbons in gas phase catalytic reactor 608 and the C₅+ hydrocarbons recovered.

FIG. 6 depicts an embodiment for treatment of the aqueous stream produced from catalytic pyrolysis of the biomass. In FIG. 6, the aqueous stream containing C₁-C₄ olefins and dienes and C₂-C₄ oxygenates is converted into a gaseous phase enriched in C₅+ hydrocarbons. Referring to FIG. 6, biomass 700 is subjected to catalytic pyrolysis in biomass conversion unit 702 to render the aqueous stream containing the C₁-C₄ olefins and dienes and C₂-C₄ oxygenates. The aqueous stream is then introduced into gas scrubber 704 into which gas stream 720 is introduced. The gas is preferably nitrogen. The resulting gaseous stream enriched in C₂-C₄ oxygenates is then fed into fixed bed catalytic (gas) reactor 718. A stream of enriched C₅+ oxygenates and C₅+ hydrocarbons are produced in reactor 718.

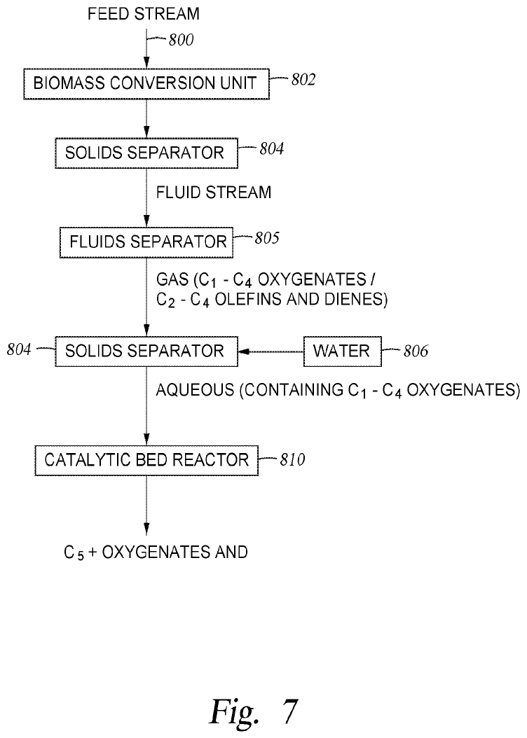

F1G. 7 depicts an embodiment for treatment of the gaseous stream produced from catalytic pyrolysis of the biomass. In FIG. 7, a process of upgrading the C₁-C₄ oxygenates in produced gas to C₅+ oxygenates in the liquid phase is illustrated. Referring to FIG. 7, solid materials from the conversion effluent are separated in solids separator 804 and the fluid stream introduced into fluids separator 805 where process gas is separated from the aqueous phase and the organic-enriched phase. The process gas containing C₁-C₄ oxygenates, C₂-C₄ olefins and dienes is absorbed into the liquid phase in scrubber 804 using water or an aqueous solution as liquid medium 806. The aqueous extracted phase enriched in C₁-C₄ oxygenates may then be upgraded to C₅+ oxygenates in liquid catalytic reactor 810 to render a C₅+ oxygenated stream.

The following examples are illustrative of some of the embodiments of the present disclosure. Other embodiments within the scope of the claims herein will be apparent to one skilled in the art from consideration of the description set forth herein. It is intended that the specification, together with the examples, be considered exemplary only, with the scope and spirit of the disclosure being indicated by the claims which follow.

### EXAMPLES

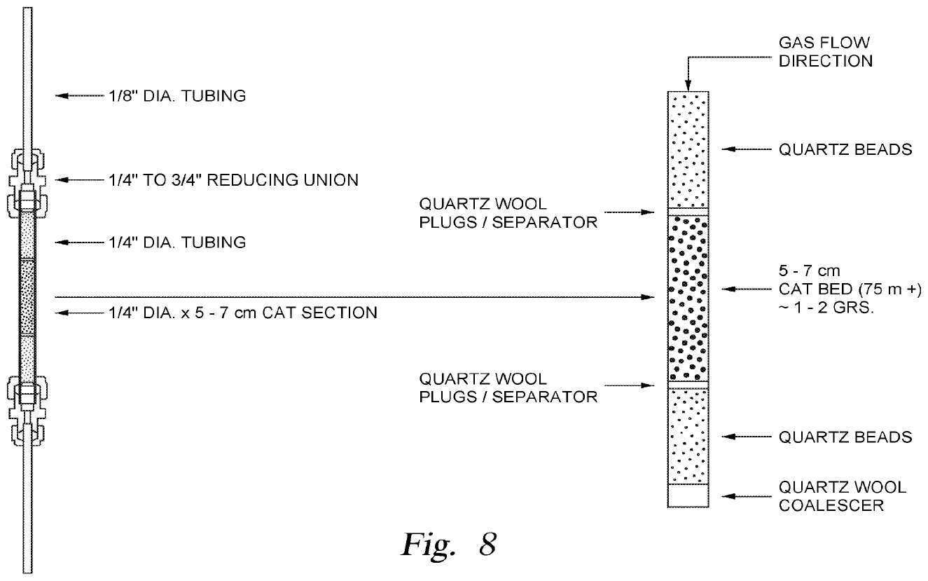

The tubular fixed bed reactor used in Examples 1 and 2 is set forth in FIG. 8 and consisted of inch tubing. The catalyst bed itself was 5-7 cm deep, holding approximately one to two grams of catalyst. Quartz beads were used before and after the catalyst zone and quartz wood was used as a separator between the catalyst and beads and also as a coalescer to recover aerosols and entrained liquids. The reactor was heated with electrical heating tape, then wrapped around a thermocouple on the exterior of the reactor tubing and connected to a temperature controller box. The tubing, thermocouple and heating tape was then wrapped with insulating tape. The reactor effluent was sent through a series of two Chemglass CG-1820-01 graduated midget impingers, which were set into an ice water bath, at around 0-1° C. in order to condense and collect condensable products.

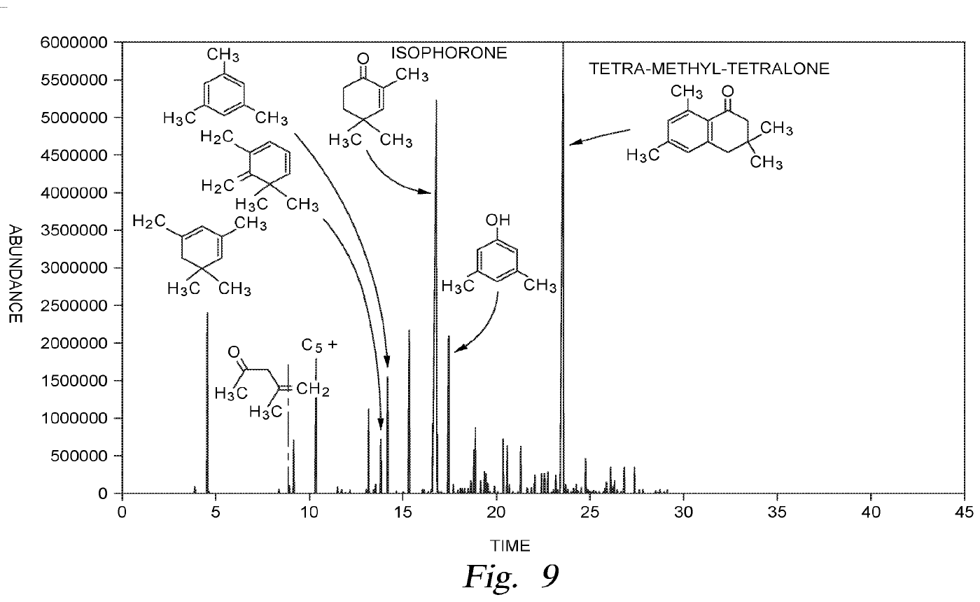

Example 1. A sample of Intercat's-Aid hydrotalcite catalyst was sieved to isolate the +75 microns particles, to remove the fines and 2.28 grams of the catalyst powder was loaded into the tubular reactor. The reactor was heated to 425° C. A feed mixture of 3.75 grams acetaldehyde and 1.64 grams of acetone was evaporated using a nitrogen gas flow through the liquid and the resulting gas stream was fed to the reactor for sixty minutes. The measured hack pressure was between 2-4 psig. The condensed liquid weighed 2.88 grams and included both oil and a water layer. The oil layer was analyzed by Gas Chromatography coupled to a Mass Spectrometer (GC-MS) confirming the formation of many compounds containing five or more contiguous carbon atoms, including, phenols, alkyl-benzenes, isophorone and tetra-methyl-tetralone. The compounds are expected to be converted to liquid hydrocarbons suitable for gasoline or diesel fuel upon hydrotreating. The experiment was repeated a second time using 1.9 grams of catalyst, 3.4 grains of acetaldehyde and 0.5 grams of acetone. This reaction was conducted at 418° C. for 45 minutes and 2.37 grams of combined oil and water were condensed. A GC-MS chromatogram for the oil is set forth in FIG. 9.

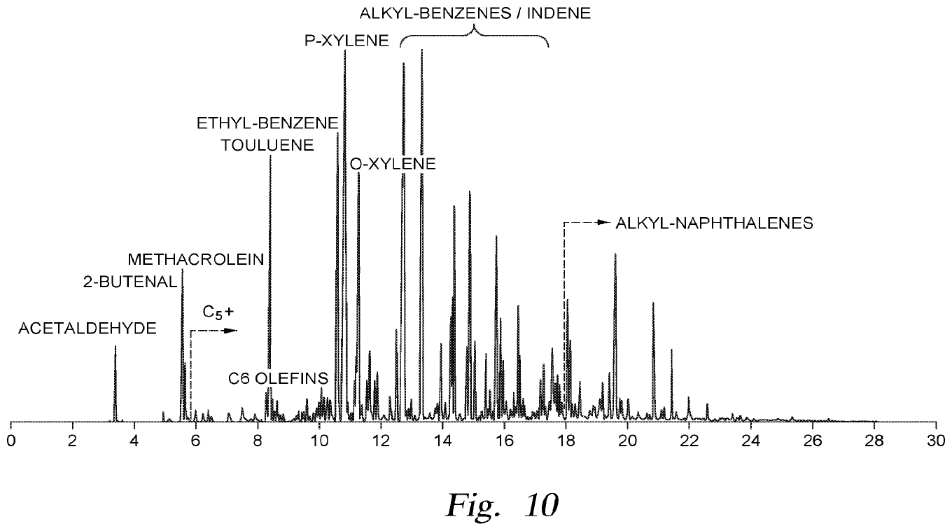

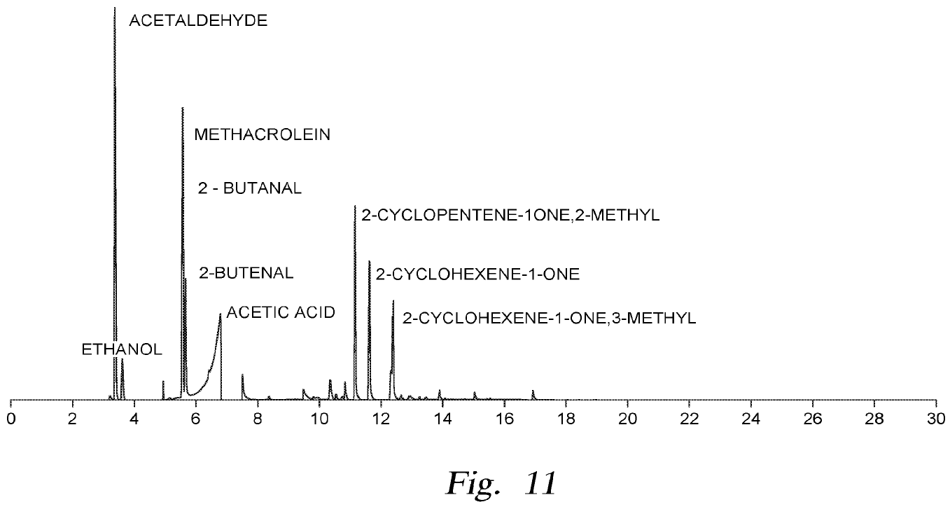

Example 2. A sample of Clariant T-4480 catalyst was ground to a fine powder and then passed through a 75-micron screen to remove the fines and 1.3 grams of this catalyst was loaded into the reactor. A gas blend containing 50% nitrogen, 30% carbon monoxide, 10% acetaldehyde, 5% propylene, 4% butadiene and 1% methyl vinyl ketone (all on a molar basis) was fed to the 370° C. catalyst bed at 200 ml min for 60 minutes and a back pressure of 5 psig. The condensed liquid contained 0.89 grams of oil and 0.5 grams of water. The oil phase (shown in FIG. 10) and the aqueous phase (shown in FIG. 11) were analyzed by GC-MS. The oil phase was found to contain a relevant concentration of aromatic hydrocarbons and the aqueous phase oxygenated compounds, both chemicals that would be suitable for liquid fuels, either directly or after their recovery and further hydrotreating to remove oxygen.

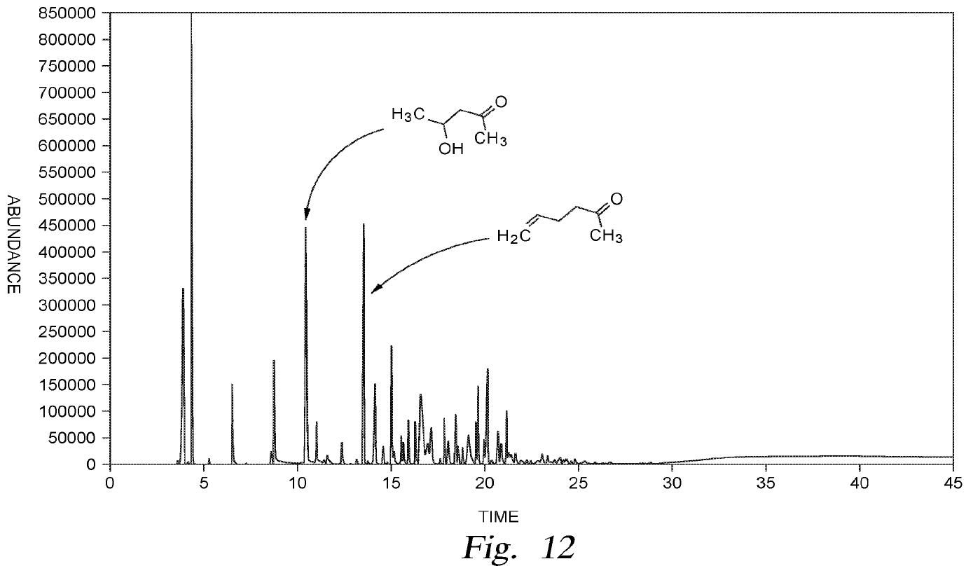

Example 3. About 27 g of deionized water, 3.14 grs of acetaldehyde, 1.5 grs of acetone and 0.14 grs of methyl vinyl ketone were loaded into a 50 ml capacity centrifuge tube. Approximately 4 grs of Intercat's hydrotalcite catalyst [+75 microns] was added. The mixture was subjected to ultrasound using an ultrasonic bath device operated at a frequency of 35 kHz, a Radio Frequency Power of 144 Watts for 40 minutes at ambient temperature. The solution turned yellow, was centrifuged to settle the dispersed catalyst and the oil-dispersed phase was shown to contain 4-hydroxy 2-pentanone and 1-hexene-5-one as major components, illustrated in the GC/MS of FIG. 12) with other higher carbon organic species.

From the foregoing, it will be observed that numerous variations and modifications may be effected without departing from the true spirit and scope of the novel concepts of the disclosure.

1. A process of upgrading C₂-C₄ olefins, C₂-C₄ dienes and/or C₁-C₄ oxygenates in produced gas and an aqueous phase to C₅+ hydrocarbons and/or C₅+ oxygenates, the produced gas and the aqueous phase comprising effluents from the catalytic pyrolysis of biomass, the process comprising:
(i) upgrading the C₂-C₄ olefins, C₂-C₄ dienes and C₁-C₄ oxygenates in the produced gas and the aqueous phase product to C₅+ hydrocarbons and C₅+ oxygenates in the gaseous phase;
(ii) upgrading the C₂-C₄ olefins, C₂-C₄ dienes and C₁-C₄ oxygenates in the produced gas and the aqueous phase product to C₅+ hydrocarbons and C₅+ oxygenates from components of produced gas absorbed into the liquid phase;
(iii) upgrading the C₂-C₄ olefins, C₂-C₄ dienes and C₁-C₄ oxygenates in the produced gas and the aqueous phase product to C₅+ hydrocarbons and C₅+ oxygenates from components in the aqueous phase vaporized into the gaseous phase; or
(iv) upgrading the C₂-C₄ olefins, C₂-C₄ dienes and C₁-C₄ oxygenates in the produced gas and the aqueous phase product to C₅+ hydrocarbons and C₅+ oxygenates from a combined gaseous stream containing C₄-Components from the produced gas and aqueous phase.

2. The process of claim 1, wherein the C₁-C₄ oxygenates are selected from the group consisting of formaldehyde, methanol, acetaldehyde, butyraldehyde, ethanol, furan, acrolein, acetone, propanal, propanol, methyl vinyl ketone, methacrolein, butanal, acetic acid, propionic acid and mixtures thereof; and the C₂-C₄ olefins and dienes are selected from the group consisting of ethylene, propylene, isobutene, butenes, propadiene, butadiene, and mixtures thereof.

3. The process of claim 1, wherein the C₂-C₄ olefins, dienes and/or C₁-C₄ oxygenates in the produced gas are upgraded to C₅+ hydrocarbons and/or C₅+ oxygenates in the gas phase.

4. The process of claim 3, wherein the C₂-C₄ hydrocarbons and/or C₁-C₄ oxygenates in the produced gas are upgraded to C₅+ hydrocarbons and C₅+ oxygenates in a fixed bed reactor.

5. The process of claim 4, wherein the temperature in the fixed bed reactor is between from about 100° C. to about 700° C.

6. (canceled)

7. The process of claim 4, wherein the gas space velocity in the fixed bed reactor is between from about 500 to about 10,000.

8. The process of claim 3, wherein the C₂-C₄ olefins in the produced gas are upgraded to C₅+ hydrocarbons and the C₁-C₄ oxygenates in the produced gas are upgraded to C₅+ oxygenates in a catalytic gas phase reactor.

9. The process of claim 8, wherein the C₁-C₄ oxygenates in the produced gas are upgraded to C₅+ hydrocarbons and C₅+ oxygenates in the catalytic gas phase reactor in the presence of a solid basic catalyst.

10. The process of claim 8, further comprising extracting soluble oxygenates from a liquid phase containing the C₅+ hydrocarbons and C₅+ oxygenates.

11. The process of claim 10, wherein the soluble organic materials are extracted from the aqueous phase with methyl isobutyl ketone or ethyl acetate.

12. The process of claim 3, wherein:
(a) the produced gas is subjected to absorption with a liquid medium to remove at least a portion of the oxygenates to produce a liquid stream enriched in oxygenates and a scrubbed process gas stream depleted of oxygenates and containing the C₁-C₄ olefins and dienes; and
(b) upgrading the C₂-C₄ hydrocarbons in the scrubbed process gas stream to C₅+ olefins in a gas phase catalytic reactor.

13. (canceled)

14. The process of claim 3, wherein:
(a) the produced gas is subjected to liquid extraction to provide a liquid stream enriched in C₁-C₄ oxygenates;
(b) extracting the C₁-C₄ oxygenates in the liquid stream enriched in C₁-C₄ oxygenates with a gaseous medium to render a gas stream enriched in C₁-C₄ oxygenates; and
(c) upgrading the C₁-C₄ oxygenates to C₅+ oxygenates and hydrocarbons in a catalytic gas phase reactor.

15. The process of claim 14, further comprising condensing the C₅+ oxygenates and hydrocarbons produced in the catalytic gas phase reactor and separating oil containing the C₅+ oxygenates and hydrocarbons,

16. The process of claim 15, further comprising mixing process water from the biomass conversion unit with the liquid stream enriched in C₁-C₄ oxygenates from step (a).

17. The process of claim 8, wherein:
(a) the produced gas containing C₁-C₄ oxygenates and C₂-C₄ olefins and dienes is first subjected to a first gas phase catalytic reactor in the presence of a first catalyst to produce a gas enriched in C₅+ hydrocarbons and oxygenate products and a gas enriched in unreacted C₂-C₄ olefins and dienes;
(b) condensing the gas enriched in C₅+ hydrocarbons and oxygenate products; and
(c) feeding the gas enriched in C₂-C₄ olefins and dienes to a second gas phase catalytic reactor in the presence of a second catalyst to render a gas enriched in C₅+ hydrocarbon products.

18. The process of claim 1, wherein the C₁-C₄ oxygenates in the produced gas are upgraded to C₅+ oxygenates in the liquid phase.

19. The process of claim 18, wherein:
(a) absorbing the C₁-C₄ oxygenates and hydrocarbons from the produced gas by scrubbing the produced gas using water as an absorption medium to produce a liquid stream enriched in C₁-C₄ oxygenates and hydrocarbons;
(b) the C₁-C₄ oxygenates in the liquid stream enriched in C₁-C₄ oxygenates are upgraded to a stream containing C₅+ oxygenates and hydrocarbons in a liquid phase catalytic reactor.

20. (canceled)

21. The process of claim 19 further comprising separating an oil phase containing the C₅+ oxygenates and hydrocarbons and an aqueous waste stream.

22. (canceled)

23. The process of claim 1, wherein the C₁-C₄ oxygenates in the produced water are upgraded to C₅+ oxygenates in the gas phase.

24. The process of claim 23, comprising:
(a) subjecting the produced water to a gaseous medium in a gas scrubber render a scrubbed gas enriched in C₁-C₄ oxygenates:,
(b) upgrading the C₁-C₄ oxygenates in the scrubbed process gas stream of step to C₅+ oxygenates and hydrocarbons in a gas phase catalytic reactor.

25. (canceled)

26. The process of claim 18, further comprising:
compressing the gas enriched in C₂-C₄ olefins and dienes and feeding the compressed gas into the second gas phase catalytic reactor at a pressure higher than the first gas phase catalytic reactor.

27. A process of enhancing the yield of biofuel from biomass catalytically converted in a biomass conversion unit, the process comprising:
(A) separating a produced gas phase and an aqueous phase product, both containing C₂-C₄ olefins, C₂-C₄ dienes and C₁-C₄ oxygenates, from effluent from the biomass conversion unit; and
(B) converting the C₂-C₄ olefins, C₂-C₄ dienes and C₁-C₄ oxygenates in the produced gas and the aqueous phase product to C₅+ hydrocarbons and C₅+ oxygenates from:
(i) produced gas in the gaseous phase;
(ii) from components of produced gas absorbed into the liquid phase;
(iii) from components in the aqueous phase vaporized into the gaseous phase; or
(iv) from a combined gaseous stream containing C4-Components from the produced gas and aqueous phase.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

52. (canceled)

54. (canceled)
